(19) United States
(12) Patent Application Publication
(10) Pub. No.: US 2023/0418059 A1
(43) Pub. Date: Dec. 28, 2023

(54) WAVEFRONT MANIPULATOR FOR HEAD-UP DISPLAY WITH HOLOGRAPHIC ELEMENT, OPTICAL ARRANGEMENT AND HEAD-UP DISPLAY

(71) Applicant: Carl Zeiss Jena GmbH, Jena (DE)

(72) Inventors: Yi Zhong, Jena (DE); Marc Junghans, Jena (DE); Daniel Thomae, Jena (DE); Roman Kleindienst, Jena (DE); Siemen Kuehl, Jena (DE); Christoph Erler, Jena (DE)

(21) Appl. No.: 18/244,283

(22) Filed: Sep. 10, 2023

Related U.S. Application Data
(63) Continuation of application No. PCT/EP2022/055513, filed on Mar. 4, 2022.

(30) Foreign Application Priority Data
Mar. 10, 2021 (DE) 10 2021 105 830.9

(51) Int. Cl. G02B 27/01

(52) U.S. Cl. CPC G02B 27/0103; G02B 2027/0105; G02B 2027/011; G02B 2027/0112

(57) ABSTRACT

A wavefront manipulator for an arrangement in the beam path of a head-up display between a picture generating unit and a projection surface is provided. The wavefront manipulator includes a holographic arrangement including at least two holographic elements. The at least two holographic elements are arranged directly behind one another in the beam path and are configured to be reflective for at least one defined wavelength and a defined angle of incidence range.

### CROSS REFERENCE TO RELATED APPLICATIONS

This application is a continuation application of international patent application PCT/EP2022/055513, filed Mar. 4, 2022, designating the United States and claiming priority to German application 10 2021 105 830.9, filed Mar. 10, 2021, and the entire content of both applications is incorporated herein by reference.

### TECHNICAL FIELD

The present disclosure relates to a wavefront manipulator for arrangement in the beam path of a head-up display (HUD) between a projection lens and a projection surface, in particular a curved projection surface. The disclosure further relates to an optical arrangement and to a head-up display.

### BACKGROUND

Head-up displays are now being used in the context of diverse applications, inter alia also in association with observation windows of vehicles, for example on windshields of motor vehicles, front screens or observation windows of aircraft. These observation windows and in particular windshields usually have a curved surface that is used as a projection surface of head-up displays.

A head-up display usually includes a picture generating unit (PGU) or a projector, a projection surface, an eyebox and a virtual image plane. An image representation is generated with the picture generating unit or the projector. The image representation is projected onto the projection surface and is projected from the projection surface into the eyebox. The eyebox is a plane or a spatial region in which the projected image representation is perceptible to an observer as a virtual image. The virtual image plane, i.e., the plane on which the virtual image is generated, is arranged on or behind the projection surface.

Imaging aberrations, or aberrations, occur as a result of the curvature of the projection surface and as a result of compact arrangements in a small installation space with, under certain circumstances, severe tilting of individual components with respect to one another and correspondingly complexly folded beam paths. A windshield can generally be described as an optical freeform surface. If a head-up display is used in association with a curved windshield or a curved observation window, then it is desirable to correct imaging aberrations that occur as a result of the curvature, the abovementioned imaging aberrations that occur for reasons of structural space, under certain circumstances, and imaging aberrations caused by the picture generating unit, if appropriate, in the optical beam path. The imaging aberrations, or aberrations, which can occur in this case are, for example, distortion, defocus, tilting, astigmatism, curvature of the image plane, spherical aberrations, higher astigmatism and coma. Moreover, the largest possible field of view, the largest possible eyebox and also a uniform, bright and multi-colored image representation are desirable in association with head-up displays, in particular for vehicle applications.

The documents DE 10 2007 022 247 A1, DE 10 2015 101 687 A1, DE 10 2017 212 451 A1 and DE 10 2017 222 621 A1 describe head-up displays for vehicles, wherein holographic optical elements are employed in DE 10 2007 022 247 A1 and DE 10 2017 212 451 A1.

### SUMMARY

Against this background, it is an object of the present disclosure to provide an advantageous wavefront manipulator for arrangement in the beam path of a head-up display between a projection lens and a curved projection surface, which wavefront manipulator at least partly corrects imaging aberrations mentioned above. Further objects are providing an advantageous optical arrangement for a head-up display at a curved projection surface, and also an advantageous head-up display.

The first object is achieved with a wavefront manipulator as described herein. The further objects are achieved with an optical arrangement and with a head-up display as described herein.

The wavefront manipulator according to an aspect of the disclosure for arrangement in the beam path of a head-up display between a picture generating unit (PGU) or a projection lens and a projection surface, for example a curved projection surface, includes a holographic arrangement. The holographic arrangement includes at least two holographic elements. The at least two holographic elements are arranged one directly behind another in the beam path. In other words, no further optical element or component is arranged between the at least two holographic elements. The at least two holographic elements are furthermore configured to be reflective for at least one defined wavelength and a defined angle of incidence range. Light waves having the at least one defined wavelength and in the defined angle of incidence range are thus diffracted efficiently. Typically, the holographic elements are configured to be transmissive for the rest, in other words transmissive to wavelengths which do not correspond to the at least one defined wavelength and have an angle of incidence outside the defined angle of incidence range.

Typically, a first holographic element includes at least one hologram assigned to a hologram of a second holographic element for reflection. In other words, the at least two holographic elements are configured such that light having at least one wavelength and at least one angle of incidence that is reflected by a first holographic element is reflected by the second holographic element.

The use of reflection holograms has the advantage that the intrinsic properties of reflection holograms can be made usable. The latter have efficiency curves that are fundamentally different from transmission holograms, the efficiency curves of reflection holograms offering a wavelength selectivity, thereby making it possible to prevent the production of double images, inter alia. The transmissive configuration for the rest and the use of reflection holograms enable filter effects between the holograms to be reduced or avoided. Typically, the at least two holographic elements are arranged one directly behind another in the beam path such that light which enters the wavefront manipulator is reflected by a first of the holographic elements and the light reflected by the first of the holographic elements is reflected by a second of the holographic elements.

The at least one holographic arrangement is typically configured for the diffraction of light having a plurality of wavelengths. For this purpose, multiple holograms, each of which diffracts light having one wavelength, and/or multiplex holograms, which diffract light having a plurality of wavelengths, can be arranged as hologram stacks.

The use of two holographic elements arranged one directly behind another and configured to be at least partly reflective has the advantage that in particular in association with a head-up display, the imaging quality can be considerably improved with the individual configuration of the holographic elements. For this purpose, the holographic elements take up almost no installation space, and so when there is only little available installation space, such as in the case of a head-up display configured for a motor vehicle, for example, a significant increase in the imaging quality can be achieved with the wavefront manipulator according to an aspect of the disclosure. The holographic arrangement achieves a high refractive power, in particular, comparable with the refractive power such as is achieved for example by an optical component configured to be transmissive without chromatic aberration. Compared with transmission holograms, reflective holograms for a defined wavelength offer a broader angular spectrum with a high efficiency and a higher wavelength selectivity. As a result, the color channels can be separated from one another despite a broad angle of incidence spectrum. The holographic arrangement thus enables a large field of view (FOV) with high efficiency at the same time and is thus suitable both for virtual reality (VR) head-up displays and augmented reality head-up displays (AR HUDs) with a large field of view and a large numerical aperture. Further application possibilities are afforded by head-up displays having curved production surfaces, for example head-up displays for windshields of vehicles, in particular motor vehicles, aircraft or ships, and generally for observation windows.

A further advantage achieved by the holographic arrangement is that, on account of the high diffraction angle of the holographic arrangement, the proportion of the light from unused orders of diffraction which is reflected into the eyebox is reduced. Furthermore, high-quality multi-colored image representations can be generated.

In one exemplary variant, the wavefront manipulator according to an aspect of the disclosure includes at least one optical element which has a freeform surface, i.e., an optically effective freeform surface, and is configured for arrangement in the beam path between the picture generating unit and the holographic arrangement. The optical element including the freeform surface contributes to an improvement in the resolution with a corresponding configuration of the freeform surface and allows a targeted correction of imaging aberrations. Furthermore, the optical element takes up only very little installation space on account of the freeform surface. In other words, it also makes a considerable contribution to an improvement in the imaging quality of a head-up display having a compact configuration.

A freeform surface should be understood in the broader sense to mean a complex surface that can be represented, in particular, with regionally defined functions, in particular twice continuously differentiable regionally defined functions. Examples of suitable regionally defined functions are (in particular piecewise) polynomial functions (in particular polynomial splines, e.g., bicubic splines, higher-degree splines of the fourth degree or higher, or polynomial non-uniform rational B-splines (NURBS)). These should be distinguished from simple surfaces, e.g., spherical surfaces, aspherical surfaces, cylindrical surfaces and toric surfaces, which are described as a circle, at least along a principal meridian. In particular, a freeform surface need not have axial symmetry and need not have point symmetry and can have different values for the mean surface power value in different regions of the surface.

The optical element having the freeform surface can be configured to be reflective and/or transmissive. A reflective configuration is particularly advantageous in association with an application for head-up displays having a compact configuration since, in this way, the optical element can simultaneously contribute to a beam deflection that is necessary anyway, even at high angles of incidence, without in the process inducing additional image aberrations such as chromatic aberrations, in particular. Typically, the freeform surface is configured to at least partly correct at least one aberration or one imaging aberration. That can be at least one of the imaging aberrations mentioned in the introduction. The imaging aberration(s) can be caused by the projection surface, in particular in the case of a curved projection surface, and/or can be caused by the picture generating unit and/or by the geometry of the beam path, for example in the context of a head-up display. Furthermore, the resolution and thus the imaging quality can be optimized with the freeform surface.

Typically, the freeform surface has a surface geometry which is derived from an imaging function dependent on at least one defined parameter. The at least one defined parameter can arise from an envisaged application of the wavefront manipulator. For example, the radius of curvature of a windshield can be used as a parameter that influences the shape of the freeform surface. The optical element can have a plurality of freeform surfaces, in particular in order to be able to perform corrections of aberrations adapted to the respective application geometry. In the context of an application in motor vehicles, for example, this makes it possible to use a uniform wavefront manipulator which can be adapted to the specific geometry of the windshield present with the specific selection or arrangement of the freeform surfaces used.

Typically, each of the at least two holographic elements includes a number, for example a plurality, of holograms. In this case, each hologram is recorded or generated with at least one defined wavelength. A holographic element can comprise a plurality of holograms, for example, which can be arranged one on top of another as a stack. With example, a holographic element can have a number, typically a plurality, of monochromatic holograms. As an alternative thereto, a holographic element can include at least one hologram which is recorded or generated with at least two defined wavelengths. Typically, such a hologram is recorded with three different wavelengths of a defined color space, for example is configured as an RGB hologram or a CMY hologram or as a hologram formed from a number of individual wavelengths of a different color space. In the examples mentioned, R stands for Red, G stands for Green, B stands for Blue, C stands for Cyan, M stands for Magenta, and Y stands for Yellow.

Therefore, at least one, typically two, of the at least two holographic elements can include at least two, typically three, holograms which are configured to be reflective for mutually different wavelengths. In addition or as an alternative thereto, at least one, typically two, of the at least two holographic elements can include at least one hologram which is configured to be reflective for at least two, typically three, mutually different wavelengths. In other words, the holograms mentioned have been recorded with correspondingly mutually different wavelengths.

The arrangement of the individual holograms of a holographic element or of the totality of the holograms of the holographic arrangement can be used as a degree of freedom in order to avoid filter effects between the holograms. The individual, mutually differing holograms of a holographic element can be arranged next to one another and/or one behind another in relation to a center line or center axis, which can coincide with the optical axis, or in relation to some other defined geometric parameter of the holographic element.

The holographic arrangement can include a first holographic element and a second holographic element, a plurality of the holograms or all of the holograms of the respective holographic element being configured identically or the same, with the exception of the wavelength for which they are configured. In other words, a plurality or all of the holograms of the first holographic element can be configured identically and can differ from one another only in regard to the wavelength for which they are configured. Analogously, a plurality or all of the holograms of the second holographic element can be configured identically and can differ from one another only in regard to the wavelength for which they are configured.

Typically, the first holographic element is arranged mirror-symmetrically with respect to the second holographic element in relation to the arrangement of the individual holograms. For example, the first holographic element can include a hologram recorded with red light, a hologram recorded with green light and a hologram recorded with blue light, which are arranged one on top of another in the order mentioned. The second holographic element can likewise have a hologram recorded with red light, a hologram recorded with green light and a hologram recorded with blue light, which are likewise arranged one on top of another in this order. In the case of a mirror-symmetrical arrangement, the first holographic element and the second holographic element are arranged one on top of another or adjacent to one another in such a way that for example the hologram of the first holographic element recorded with red light is arranged directly adjacent to the hologram of the second holographic element recorded with red light. As an alternative thereto, the arrangement of the holograms of the first holographic element can be identical to the arrangement of the holograms of the second holographic element in relation to a defined direction. For example, both holographic elements can have holograms arranged in the order RGB (R—hologram recorded with red light, G—hologram recorded with green light, B—hologram recorded with blue light) in relation to a defined direction, which are arranged against one another in such a way that the hologram R of one holographic element adjoins the hologram B of the other holographic element. Any other mutually different arrangements are likewise possible, for example RGB adjoining or adjacent to GBR etc.

In a further advantageous variant, a plurality of the holograms of at least one of the holographic elements are recorded with two design wavefronts. Of the latter, at least one design wavefront of at least one hologram of the holographic elements is identical to at least one design wavefront of another hologram of one of the holographic elements, in particular of the first and/or of the second holographic element, with regard to the wavelength and the angle of incidence. The use of identical design wavefronts for different wavelengths has the advantage that the required holograms can be produced with little outlay and high precision.

The jointly used design wavefront is typically defined as a plane wave which leads to a minimal filter effect between different wavelengths and additionally has the advantage that positioning tolerances of the holograms assigned to a color with respect to one another can be chosen more generously compared with the use of a non-plane wave. In other words, varying distances between the holograms in the direction of the optical axis and/or in a lateral direction, i.e., perpendicular to the optical axis, are possible without an adverse effect on the imaging quality.

The holographic arrangement, in particular at least one of the holographic elements, can be configured such that one freeform wavefront is transformed into another freeform wavefront. The holographic arrangement, in particular at least one of the holographic elements, can be configured such that it transforms a spherical wave into a plane wave. As a result, the holographic arrangement, in particular the holographic element, has a high refractive power, without the volume and thus the required installation space being increased. Furthermore, the beam cross-section on the mirror decreases, as a result of which both the size and the refractive power of the mirror can be reduced. This is additionally advantageous since the refractive powers can be better distributed in the system and the latter becomes less sensitive to tolerances. Furthermore, at least one of the holographic elements can be configured such that it transforms a freeform wavefront into a plane wavefront or transforms a spherical wave into a freeform wavefront. At least one hologram can be recorded or exposed with waves having at least one freeform wavefront. As a result, various aberrations can be corrected, and the performance can be improved. By virtue of the fact that, in the case of such a configuration, it is possible to transform light with an arbitrary wavefront such as can also be generated with freeform surfaces, for example, the number of components having freeform surfaces, such as lens elements and/or mirrors, can be reduced. Plane waves and/or spherical waves can also be used for the exposure of the holograms. The use of wavefronts configured as simply as possible for the exposure of the holograms enables the production costs to be reduced.

The direction of incidence of the design wavefront for the at least two holographic elements of the holographic arrangement can be used as a degree of freedom in order to avoid filter effects between different wavelengths. The direction of incidence can also be chosen differently for each wavelength. Typically, the design wavefronts for the at least two wavelengths, typically for this the three wavelengths, are the same design wavefronts for each holographic element and differ only in the wavelength used.

The distance between the holograms and the thickness thereof are negligibly compared with the dimension or the extent of the wavefront manipulator or of an optical arrangement including the wavefront manipulator. The holographic arrangement is therefore free of aberrations potentially caused by an extent in the direction of an optical axis. The design wavefronts of the holographic elements can furthermore be used as a degree of freedom for the compensation of material tolerances, for example for the compensation of material shrinkages. In this case, the general design wavefronts differ slightly from one another.

Typically, the at least two holographic elements are arranged at a distance from one another of less than one millimeter, in particular of less than 0.5 millimeters, typically of less than 0.1 millimeters. The distance is typically zero or negligible. As a result, firstly, a high imaging quality is achieved; additionally, the individual holographic elements do not have to be subsequently adjusted in regard to their position with respect to one another.

The holographic arrangement can be configured in the form of a layer or a film or a substrate, for example in the form of a volume hologram, or a plate. In addition or as an alternative thereto, the holographic arrangement can have a planar surface or a curved surface. The holographic arrangement can be arranged or have been arranged for example at or on a surface of a cover glass or of some other optical component that is present anyway. In this way, no additional installation space is taken up. For example, the wavefront manipulator can include an optical component configured to be transmissive and configured to be arranged in the beam path between the holographic arrangement and the projection surface. In this case, the holographic arrangement can typically be arranged at a surface—which faces away from the projection surfaces—of the optical component configured to be transmissive. Both the optical component fashioned to be transmissive and the holographic arrangement can be configured to be curved, typically with the same curvature. The aforementioned optical component fashioned to be transmissive can be a so-called glare trap, for example, which is usually arranged at a position between a windshield and a head-up display and which is configured to reflect sunlight in a defined direction such that it is not reflected in the direction of the eyebox via the head-up display. In this configuration variant, the holographic arrangement and the glare trap are typically configured with the same curvature and arranged directly adjacent to one another.

Typically, the wavefront manipulator is configured to generate or to project multi-colored image representations. A multi-colored image representation is understood to mean an image representation which images an image having a plurality of colors in at least one region of the image representation, in particular a region of an imaging plane, typically at each image point. Typically, in the case of a multi-colored image representation, each point of the image representation or image point can have an arbitrary color. In other words, an image having a plurality of colors can be imaged in each region of the image representation with the wavefront manipulator. The image representation or imaging plane is for example a virtual image representation or imaging plane.

Advantageously, at least one of the holographic elements, typically two of the holographic elements, is configured efficiently for a plurality of angles of incidence and/or for a plurality of angle of incidence ranges that do not overlap one another. The at least two holographic elements are typically configured such that a first holographic element includes at least one hologram assigned to a hologram of a second holographic element, in particular assigned thereto for reflection. In other words, the at least two holographic elements are configured such that light having at least one wavelength and at least one angle of incidence that is reflected by a first holographic element is reflected by the second holographic element. Typically, holograms assigned to one another are configured with pointwise diffraction efficiency in relation to one another. In order to determine the diffraction efficiency, either the intensity of the 1st order of diffraction is expressed as a ratio with respect to the sum of the intensity of the 1st order of diffraction and the intensity of the 0 order of diffraction, or the intensity of the 1st order of diffraction is expressed as a ratio with respect to the total incident intensity. With pointwise diffraction efficiency thus means, in other words, that at least one point of the first holographic element is configured to diffract light having at least one defined wavelength and in a defined angle of incidence range to a point of the second holographic element which in turn diffracts the light diffracted by the first holographic element. For example, the first hologram can be configured to diffract waves having one wavelength and one angle of incidence with an efficiency of more than 90 percent to the second hologram, and the second hologram can be configured to diffract the waves diffracted by the first hologram with an efficiency of more than 90 percent in the final, desired direction. This fosters the projection of a multi-colored image representation, in particular a multi-colored image representation corrected in respect of imaging aberrations.

Reflection holograms assigned to one another, i.e., holograms which are configured for reflecting wavelengths or frequencies coordinated with one another, i.e., identical wavelengths or frequencies or wavelength ranges or frequency ranges which at least partly overlap one another, and/or for angle of incidence ranges coordinated with one another or have at least a pointwise mutual efficiency, can be arranged directly adjacent to one another within the holographic arrangement. However, it can also include a first holographic element including a plurality of first holograms which are configured and are efficient in each case for different wavelengths or wavelength ranges, and a second holographic element including a plurality of second holograms which are respectively assigned to the first holograms, i.e., are configured or efficient for the same wavelengths or wavelength ranges as the first holograms. In this case, the first holographic element and the second holographic element can typically be arranged directly adjacent to one another. In order to avoid filtering effects, the holograms are typically configured to be transmissive for those wavelengths or frequencies of the color space used for which they are not efficient or configured as reflection holograms.

In a further exemplary variant, the holographic arrangement is configured in curved fashion, i.e., it has at least one curved surface. This configuration has the advantage that, firstly, an adaptation to specific installation space requirements can be effected with the curvature and, secondly, a correction of imaging aberrations can be performed with the curvature. In addition, the holographic arrangement configured in curved fashion can function as a glare trap and minimize extraneous light or can be arranged efficiently in terms of installation space in association with a glare trap.

Overall, the wavefront manipulator according to an aspect of the disclosure, with the holographic elements, enables a significantly larger or more extreme deflection of the used light than is possible with traditional refractive optical components. Moreover, high-quality multi-colored image representations are able to be projected.

The optical arrangement according to an aspect of the disclosure for a head-up display at a projection surface, in other words optical arrangement of a head-up display for generating a virtual image representation at or behind a projection surface, for example a curved projection surface, includes a picture generating unit and a wavefront manipulator described above. The picture generating unit advantageously includes a plane, i.e., is spatially extended, the plane being configured to emit light in a defined emission angle range and with a defined maximum bandwidth with regard to the wavelengths of the emitted light. Typically, each light-emitting point of the plane emits light in the form of a scattering lobe or in a defined angular range. This can be achieved for example with a diffuser. Typically, the picture generating unit is configured to emit laser light, in particular laser beams. Advantageously, the picture generating unit is configured to emit laser light in at least two, typically at least three, different waves. That typically involves three different wavelengths of a defined color space, for example red, green and blue or cyan, magenta and yellow. Since the holographic elements are more sensitive with regard to the bandwidth of each wavelength compared with other optical components, such as mirrors and lens elements, for example, it is advantageous if the picture generating unit is configured as a laser scanner having a sharp bandwidth for each color.

The optical arrangement according to the disclosure typically has a volume of less than 15 liters, e.g., less than 10 liters, i.e., in other words occupies an installation space of less than 15 liters, e.g., less than 10 liters. The optical arrangement according to the disclosure has the features and advantages already mentioned above in connection with the wavefront manipulator according to an aspect of the disclosure. It offers in particular a head-up display which is fashioned very compactly, i.e., occupies just a small installation space, and at the same time ensures a very high imaging quality. Furthermore, the use of a wavefront manipulator according to an aspect of the disclosure enables an efficient arrangement of the picture generating unit in terms of installation space, in particular an arrangement below the wavefront manipulator, since the holographic arrangement can be operated in transmission.

Both the wavefront manipulator according to an aspect of the disclosure and the optical arrangement according to an aspect of the disclosure are suitable for retrofitting in for example motor vehicles, aircraft or virtual reality (VR) arrangements, for example VR glasses.

The head-up display according to an aspect of the disclosure includes a curved projection surface and an above-described optical arrangement according to an aspect of the disclosure. The curved projection surface is, for example, a windshield of a vehicle, for example of a motor vehicle, of an aircraft or of a ship. However, the curved projection surface can also be some other observation window, for example an observation window of VR glasses. The observation window can be glasses, in particular smart glasses, a head-wearable transparent screen, AR glasses or an AR helmet, a visor or an eyepiece of a microscope. The curved projection surface can be regarded as a freeform surface, for example. Imaging aberrations, or aberrations, that are caused thereby are compensated for with the wavefront manipulator according to the disclosure.

The head-up display according to an aspect of the disclosure makes it possible to generate a virtual image with a large field of view. For example, it is possible to generate a rectangular virtual image which has a field of view of, for example, at least 10 degrees, typically at least 15 degrees times 5 degrees (FOV: 15°×5°), and is observable at a specific distance away from the eyebox, for example at a distance of between 6 meters and 12 meters. The eyebox can have a dimension of up to 150 mm×150 mm.

The brightness and the uniformity of the virtual image can be optimized with corresponding design waves of the holographic elements. Furthermore, the uniformity of the degree of whiteness can be set by setting of the factor of the color mixture, for example of the RGB color space in the picture generating unit.

The disclosure is explained in larger detail below on the basis of exemplary embodiments with reference to the accompanying figures. Although the disclosure is more specifically illustrated and described in detail with the exemplary embodiments, nevertheless the disclosure is not restricted by the examples disclosed and other variations can be derived therefrom by a person skilled in the art, without departing from the scope of protection of the disclosure.

The figures are not necessarily accurate in every detail and to scale, and can be presented in enlarged or reduced form for the purpose of better clarity. For this reason, functional details disclosed here should not be understood to be limiting, but merely to be an illustrative basis that gives guidance to a person skilled in this technical field for using the present disclosure in various ways.

The expression “and/or” used here, when it is used in a series of two or more elements, means that any of the elements listed can be used alone, or any combination of two or more of the elements listed can be used. For example, if a structure is described as containing the components A, B and/or C, the structure can contain A alone; B alone; C alone; A and B in combination; A and C in combination; B and C in combination; or A, B, and C in combination.

### BRIEF DESCRIPTION OF THE DRAWINGS

The disclosure will now be described with reference to the drawings wherein:

FIG. 1 schematically shows the beam path of a head-up display for a windshield of a motor vehicle in a side view according to an exemplary embodiment of the disclosure,

FIG. 2 schematically shows the beam path of the head-up display shown in FIG. 1 including a virtual image in a perspective view,

FIG. 3 schematically shows a holographic arrangement of a first variant of a wavefront manipulator according to an exemplary embodiment of the disclosure,

FIG. 4 schematically shows a holographic arrangement of a second variant of a wavefront manipulator according to an exemplary embodiment of the disclosure,

FIG. 5 schematically shows the beam path within the holographic arrangement,

FIG. 6 schematically shows a head-up display according to a further exemplary embodiment of the disclosure, and

FIG. 7 schematically shows an optical arrangement with a wavefront manipulator in the form of a block diagram according to an exemplary embodiment of the disclosure.

### DESCRIPTION OF EXEMPLARY EMBODIMENTS

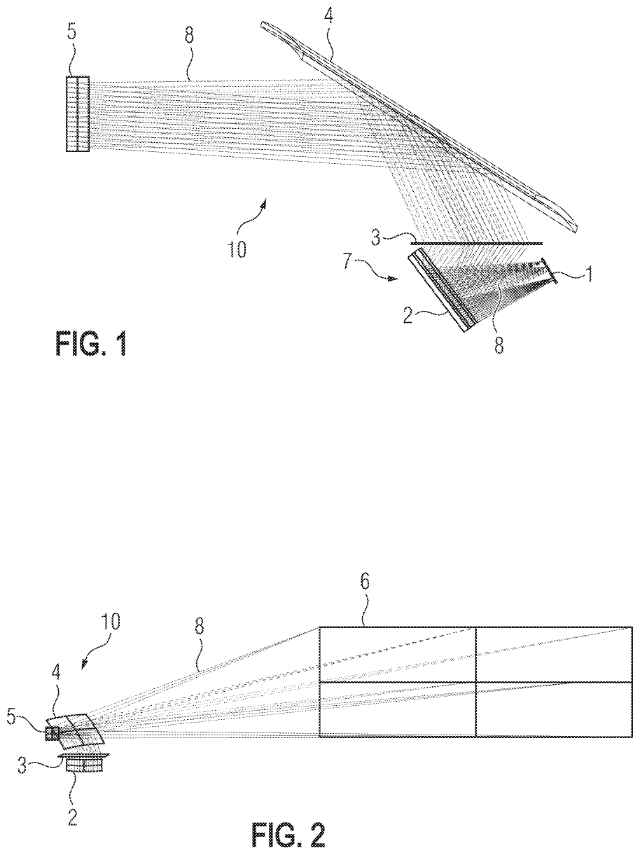

FIGS. 1 and 2 schematically show the beam path of a head-up display 10 according to an exemplary embodiment of the disclosure. The head-up display 10 includes a picture generating unit 1, a projection surface 4, for example in the form of a windshield of a motor vehicle, and a wavefront manipulator 7. The projection surface 4, for example the windshield, can be configured in curved fashion. In the case of an application for a vehicle, the picture generating unit 1 and the wavefront manipulator 7 are typically arranged in a manner integrated in a fitting (not shown). The head-up display 10 is configured such that it generates a virtual image 6 on the projection surface 4, in particular on the surface of the windshield or in the external region of the vehicle, for example in the direction of travel behind the surface of the windshield.

In the configuration variant shown, the wavefront manipulator 7 includes a holographic arrangement 3 and an optical element 2 which is configured to be reflective and which has a freeform surface and is arranged in the beam path 8 proceeding from the picture generating unit 1 between the picture generating unit 1 and the holographic arrangement 3. The optical element 2 is typically configured as a freeform mirror.

The picture generating unit 1 emits light waves in the direction of the wavefront manipulator 7. The wavefront manipulator 7 is used to correct imaging aberrations and optionally to expand the beam path. The wavefront manipulator 7 guides light waves in the direction of the projection surface 4, in particular the curved projection surface. At the projection surface 4, the light waves are reflected in the direction of an eyebox 5. In this case, the eyebox 5 forms the region in which a user must or can be situated in order to be able to perceive the virtual image 6 generated by the head-up display 10.

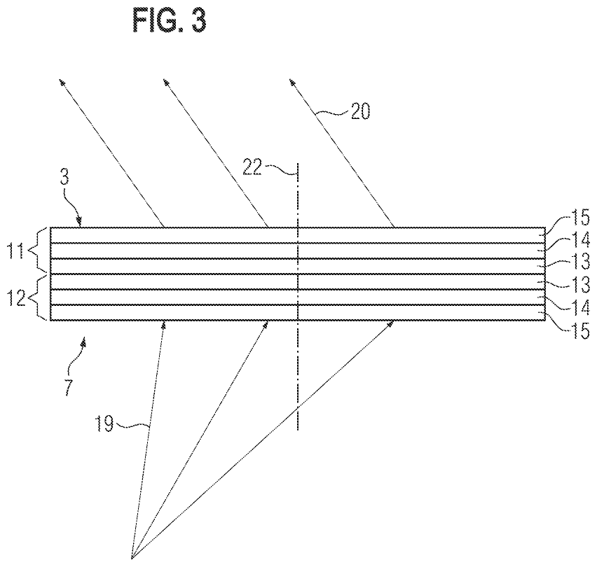

FIG. 3 schematically shows a holographic arrangement 3 of a wavefront manipulator 7 according to an aspect of the disclosure. The wavefront manipulator 7 has the holographic arrangement 3. The holographic arrangement 3 includes a first holographic element 11 and a second holographic element 12. In the exemplary embodiment variant shown, the first holographic element 11 and the second holographic element 12 each have three monochromatic holograms arranged one on top of another, of which with example a hologram recorded with red light is identified by the reference numeral 13, a hologram recorded with green light is identified by the reference numeral 14 and a hologram recorded with blue light is identified by the reference numeral 15. The first holographic element 11 and the second holographic element 12 are arranged against one another in such a way that the individual holograms are arranged mirror-symmetrically with respect to one another. In the variant shown, the holograms 13 recorded with red light are arranged directly adjacent to one another. The first holographic element 11 and the second holographic element 12 can be directly adjacent to one another or can be arranged at a negligible distance from one another, typically at a distance of less than 1 millimeter.

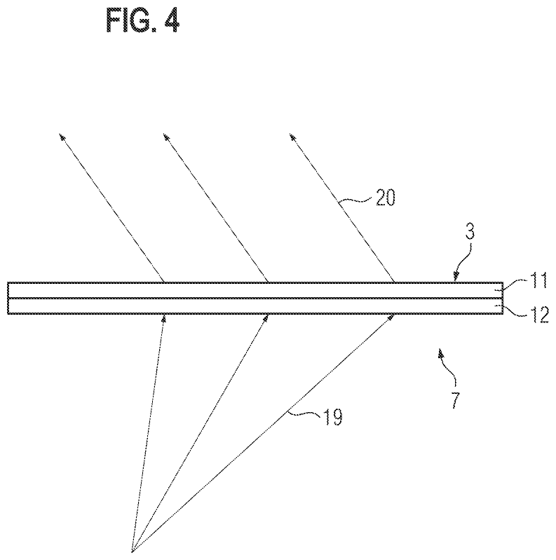

In FIGS. 3 and 4, the incident light waves in the form of beams are identified by arrows with the reference numeral 19 and the beam path of the light leaving the wavefront manipulator 7 is identified by arrows with the reference numeral 20. In the variant shown in FIG. 3, the individual, mutually differing holograms 13, 14 and 15 of the individual holographic elements 11 and 12 are arranged one behind another in relation to a center line or center axis 22, which can be an optical axis, along the latter. Individual, mutually differing holograms 13, 14 and 15 of the individual holographic elements 11 and 12 can also be arranged laterally with respect to one another in relation to a center line or center axis 22.

FIG. 4 shows a further exemplary embodiment variant of a wavefront manipulator 7 according to an aspect of the disclosure. In a departure from the variant shown in FIG. 3, the first holographic element 11 and the second holographic element 12 each include only one hologram, which however is recorded in each case with light having a number of different wavelengths. The variant shown involves two RGB holograms with example. The holograms have for example hologram grating structures produced with red light, hologram grating structures recorded with green light and hologram grating structures recorded with blue light.

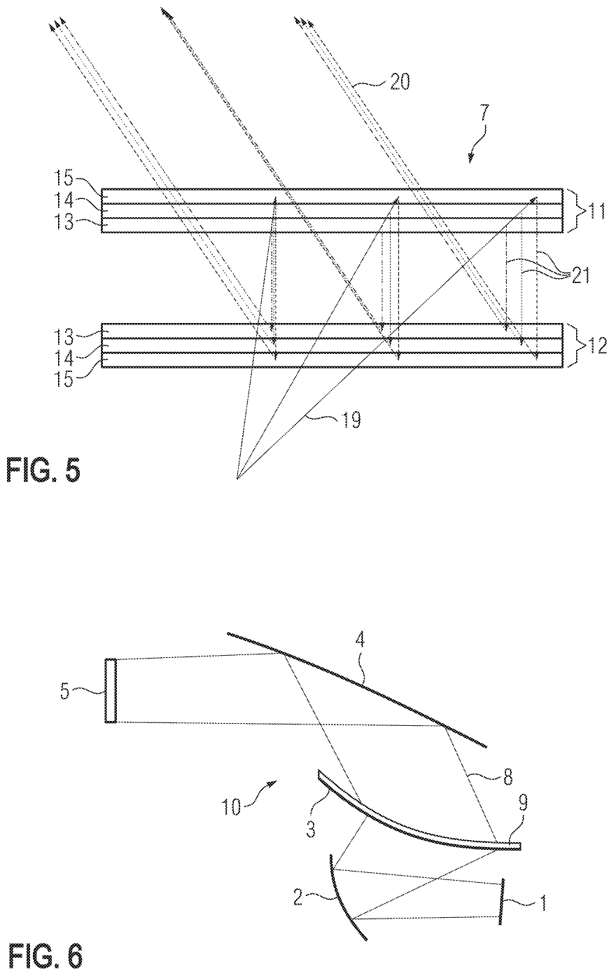

FIG. 5 schematically shows the beam path within the holographic arrangement 3. For illustration purposes, here the first holographic element 11 and the second holographic element 12 are arranged at a distance from one another. However, this only serves to illustrate the beam path. In this case, the incident light 19 is reflected at the individual holograms 13-15 or the hologram grating structures 13-15 wavelength-specifically for specific angle of incidence ranges, that is to say blue light with a specific angle of incidence at the holograms 15 recorded with blue light, green light in a specific angle of incidence range at the holograms 14 recorded with green light, and red light correspondingly at the holograms 13 recorded with red light. In the variant shown, incident light 19 is firstly transmitted through the second holographic element 12 and is reflected at the first holographic element 11. The light 21 reflected by the first holographic element 11 is reflected at the second holographic element 12 and forms the wavefront 20 leaving the wavefront manipulator 7.

In one exemplary embodiment variant, the wavefront manipulator 7 according to an aspect of the disclosure includes, in addition to the holographic arrangement 3, an optical element 2 which includes a freeform surface and is typically configured to be reflective, said optical element already having been described in association with FIGS. 1 and 2.

FIG. 6 schematically shows a further exemplary embodiment variant of a head-up display according to an aspect of the disclosure, in particular for a motor vehicle application. In addition to the components already described, the head-up display 10 shown in FIG. 6 has a transmissive optical component 9 configured in curved fashion, typically a so-called glare trap. In the variant shown, the holographic arrangement 10 has a curvature corresponding to the geometry of the glare trap and is arranged directly at the latter. This has the advantage that a high imaging quality is achieved with only very little installation space.

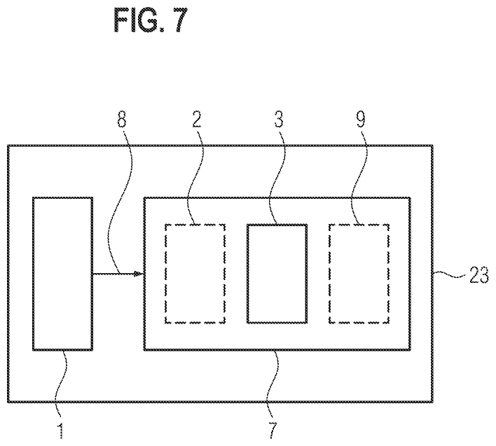

FIG. 7 schematically shows an optical arrangement 23 according to an aspect of the disclosure with a wavefront manipulator 7 according to an aspect of the disclosure in the form of a block diagram. The optical arrangement 23 according to an aspect of the disclosure includes a picture generating unit 1 and a wavefront manipulator 7 according to an aspect of the disclosure, which are arranged one behind another in a beam path 8. The wavefront manipulator 7 includes a holographic arrangement 3 already described, and optionally an optical element 2 already described in association with FIGS. 1 and 2, said optical element having a freeform surface and typically being configured as a freeform mirror. In this case, the optical element 2 is arranged in a beam path between the picture generating unit 1 and the holographic arrangement 3. In addition, a transmissive optical component 9 already described in association with FIG. 6, in particular a glare trap, can be present, which is arranged in a beam path between the holographic arrangement 3 and a projection surface. The optional components 2 and 9 are depicted using dashed lines in FIG. 7.

It is understood that the foregoing description is that of the exemplary embodiments of the disclosure and that various changes and modifications may be made thereto without departing from the spirit and scope of the disclosure as defined in the appended claims.

### LIST OF REFERENCE NUMERALS

1 Picture generating unit
2 Optical element
3 Holographic arrangement
4 Projection surface
5 Eyebox
6 Virtual image
7 Wavefront manipulator
8 Beam path
9 Transmissive optical component/glare trap
10 Head-up display
11 First holographic element
12 Second holographic element
13 Hologram
14 Hologram
15 Hologram
19 Beam path
20 Beam path
21 Beam path
22 Centre axis
23 Optical arrangement

What is claimed is:

1. A wavefront manipulator for an arrangement in a beam path of a head-up display between a picture generating unit and a projection surface, the wavefront manipulator comprising:
a holographic arrangement comprising at least two holographic elements, the at least two holographic elements being arranged directly behind one another in the beam path and configured to be reflective for at least one defined wavelength and a defined angle of incidence range.

2. The wavefront manipulator as claimed in claim 1, further comprising:
at least one optical element which has a freeform surface and is configured to be arranged in the beam path between the picture generating unit and the holographic arrangement.

3. The wavefront manipulator as claimed in claim 1, wherein each of the at least two holographic elements comprises a plurality of holograms.

4. The wavefront manipulator as claimed in claim 1, wherein at least one of the at least two holographic elements comprises at least two holograms configured to be reflective for mutually different wavelengths, and/or
wherein at least one of the at least two holographic elements comprises at least one hologram configured to be reflective for at least two mutually different wavelengths.

5. The wavefront manipulator as claimed in claim 1, wherein in relation to the arrangement of the individual holograms in relation to a defined direction, the first holographic element is arranged identically or mirror-symmetrically with respect to the second holographic element.

6. The wavefront manipulator as claimed in claim 1, wherein a plurality of the holograms of at least one of the holographic elements are recorded with two design wavefronts, of which at least one design wavefront of at least one hologram of the holographic elements is identical to at least one design wavefront of another hologram of one of the holographic elements with regard to the wavelength and the angle of incidence.

7. The wavefront manipulator as claimed in claim 1, wherein the at least two holographic elements are arranged at a distance from one another of less than 1 millimeter.

8. The wavefront manipulator as claimed in claim 1, wherein the holographic arrangement is configured in a form of a layer or a film or a substrate or a plate and/or has a planar surface or a curved surface.

9. The wavefront manipulator as claimed in claim 1, wherein the optical element is configured to be reflective and/or transmissive.

10. The wavefront manipulator as claimed in claim 1, wherein the freeform surface of the optical element is configured to at least partly correct at least one aberration.

11. The wavefront manipulator as claimed in claim 1, further comprising:
an optical component configured to be transmissive and to be arranged in the beam path between the holographic arrangement and the projection surface.

12. The wavefront manipulator as claimed in claim 1, wherein the wavefront manipulator is configured to project multi-colored image representations.

13. The wavefront manipulator as claimed in claim 1, wherein at least one of the holographic elements is configured efficiently for a plurality of angles of incidence and/or for a plurality of angle of incidence ranges that do not overlap one another.

14. The wavefront manipulator as claimed in claim 1, wherein the holographic arrangement is configured in a curved fashion.

15. An optical arrangement for a head-up display at a projection surface, the head-up display including a picture generating unit, the optical arrangement comprising:
a wavefront manipulator as claimed in claim 1.

16. The optical arrangement as claimed in claim 15, wherein the picture generating unit comprises a plane configured to emit light in a defined emission angle range and with a defined maximum bandwidth with regard to the wavelengths of the emitted light.

17. The optical arrangement as claimed in claim 16, wherein the picture generating unit is configured to emit laser light in at least two different wavelengths.

18. The optical arrangement as claimed in claim 15, wherein the optical arrangement has a volume of less than 10 liters.

19. A head-up display comprising:
a projection surface, wherein the head-up display comprises an optical arrangement as claimed in claim 15.
